(19) United States
(12) Patent Application Publication
(10) Pub. No.: US 2005/0050119 A1
(43) Pub. Date: Mar. 3, 2005

(54) Method for reducing data dependency in codebook searches for multi-ALU DSP architectures

(76) Inventor: Naveen Kumar Vandanapu, Andhra Pradesh (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/649,565

(22) Filed: Aug. 26, 2003

(51) Int. Cl. G06F 7/00

(52) U.S. Cl. 708/207

(57) ABSTRACT

Performing a search of a set of ratios for a maximum or minimum using parallel processing blocks. Various computations related to processing the ratios to determine which is a best value are performed in parallel processing blocks. Splitting the computations into parallel processing paths localizes sequential data dependency by localizing ratio computation and comparison to elements associated with each separate block. After each block determines a local best value, a global best value may be determined.

### FIELD

A method and apparatus for determining a maximum or minimum ratio is described. Specifically, use of parallel processing architectures to reduce sequential data dependency in ratio maximization and minimization is described.

### BACKGROUND

A ratio is a value that represents a comparison of one number with respect to another. A common mathematical representation of a ratio is as a fraction, with one number as the numerator and the other number as the denominator. The mathematical concept of a ratio is utilized in many applications. Some applications involve searching a set of values, each element of the set being a ratio, and to find a maximum or minimum ratio among the set. So-called ratio maximization algorithms search the set to find a ratio, r₁, which is greater than a predetermined maximum ratio, rₘₐₓ, which is either an initial value or the maximum value from among ratios already searched. This means a determination is made whether r₁>rₘₐₓ. Knowing that the ratios consist of a numerator and denominator, this can be represented by the equation:

$$\frac{{n}_{1}}{{d}_{1}} > \frac{{n}_{max}}{{d}_{max}} , \qquad ( 1 )$$

where n₁ is the numerator of r₁, d₁ is the denominator of r₁, and nₘₐₓ and dₘₐₓ are the numerator and denominator, respectively, of rₘₐₓ against which r₁ is being tested to see if the condition of equation (1) is satisfied.

Note that algebraic manipulation shows that equation (1) can be solved by testing the condition:

$$\frac{{n}_{1}}{{d}_{1}} - \frac{{n}_{max}}{{d}_{max}} > 0 , \qquad ( 2 )$$

which is equivalent to:
n₁*dₘₐₓ−nₘₐₓ*d₁>0, (3)
which is typically computationally simpler than equation (2) in current processors. Note that in the case of ratio minimization, r₁<rₘᵢₙ is sought, making equation (3) become:
n₁*dₘᵢₙ−nₘᵢₙ*d₁>0, (4)
for ratio minimization.

One technology that uses the above principles is speech compression, a technique for representing speech in digital format with as few bits as possible without losing the quality of the signal. Its application in telecommunications has resulted in an increase in channel density for affordable capacity. Many algorithms have been developed for compressing speech signals efficiently. Currently, CELP (Code Excited Linear Prediction) based codecs (a device that includes both encoder and decoder functions) are of predominantly preferred codecs towards achieving excellent ratio of quality to computational complexity.

One CELP standard, Algebraic CELP (ACELP) teaches that an encoder determines an algebraic codebook index to transmit to the receiving decoder to enable the receiving system to extract the excitation pulse positions and amplitudes (signs), and find the algebraic codevector. The index is determined by searching through the algebraic codebook for an index where the ratio is maximized. This search is traditionally performed by solving equation (3). When searching through the algebraic codebook for the index corresponding to the ratio of most optimum value, the search is traditionally performed by comparing an initial value for rₘₐₓ, and then testing a ratio against it. If the ratio is greater than that of rₘₐₓ (meaning equation (3) is satisfied), rₘₐₓ is replaced by the ratio, and the process is repeated until the entire codebook has been searched.

One problem with this approach is that there is inherent sequential data dependency between successive iterations of the search. This is because for each iteration, it must be determined whether the ratio tested is greater than rₘₐₓ, making it impossible to know what value to use for rₘₐₓ on the next iteration until the previous iteration is complete. The inherent sequential data dependency produces inefficiency in the ratio maximization step of the algebraic codebook search. More generally, the inherent sequential data dependency of any serial sequential search for maximum and minimum ratios results in inefficiency.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment of a block diagram of a processor.

FIG. 2 is one embodiment of a block diagram of a ratio comparing circuit.

FIG. 3 is one embodiment of a block diagram of a flow diagram of ratio maximization.

FIG. 4 is one embodiment of a block diagram of elements of a speech compression system.

### DETAILED DESCRIPTION

Methods and apparatuses for finding a maximum or minimum ratio are described. Various operations relating to searching for a ratio maximum or minimum among various ratios are performed in parallel processing blocks. Splitting the elements to be searched among the processing blocks reduces search time by localizing sequential data dependency to each separate processing block. After each block determines a local best value, a global value may be determined.

Many of the examples contained herein are applicable to the ratio maximization of the algebraic codebook search of the AMR (Adaptive Multi-Rate, based on the ACELP) speech codec standard. However, it will be noted that embodiments of the invention are applicable for use outside the AMR speech codec. The method and apparatus described herein are applicable wherever a ratio maximization or ratio minimization function is performed.

The term “ratio optimization” will be used herein to refer to ratio maximization and ratio minimization. Likewise, the term “optimum” will be used herein to refer to certain best values found as a result of ratio maximization or ratio minimization. The terms “optimization” and “optimum” shall be construed herein to refer to relative optimums, rather than an absolute optimum. A relative optimum means determining a best value from among a finite set of choices. Thus, the “optimum” value selected may or may not be objectively an ideal, and hence may or may not be an absolute maximum or minimum, but will be the value from among a set of possible values that is nearest the objectively ideal value. For example, in a ratio minimization search, an optimum value would be the lowest ratio value of the set of values searched.

FIG. 1 is one embodiment of a block diagram of a processor. Processor 100 is a processor to be used in a system that will perform ratio optimization. Processor 100 may be, for example, a Digital Signal Processor (DSP), an Application Specific Integrated Circuit (ASIC), a general purpose Central Processing Unit (CPU), etc. The key is that processor 100 includes parallel processing blocks 120. The novelty of processor 100 is that processor 100 is adapted, through hardware design, programming, or a combination, to utilize processing blocks 120 in parallel to perform ratio optimization.

Processor 100 includes control logic 110 to direct the flow of instructions that will direct the operations of processor 100. The instructions may be received from another logic unit coupled with processor 100, from a data bus, or from memory in a system of which processor 100 is a part. The instructions may also be received from a storage medium that is accessible by a machine, such as processor 100, such as by a form of disk storage. In general, a machine-accessible medium is to be understood as a technology that provides (i.e., stores and/or transmits) information in a manner in which a man-made device may access the information. A man-made device includes, e.g., a computer, a processor, a personal digital assistant (PDA), a manufacturing tool, an electronic circuit, etc. For example, information could be provided via ROM, RAM, magnetic disk storage, optical disk storage, flash memory, or electrical, optical, acoustical, or other form of propagated signal, etc., to any number of man-made devices. Instructions may also be received at control logic 110 over a wired or wireless connection to direct the operation of processor 100 through programming or instructions for execution.

Processor 100 includes processing blocks 120. The architecture of processor 100 provides for parallel operation of processing blocks 120. Thus, processing blocks 120 are parallel processing units that perform operations on separate groups of data at the same time as each other. In one embodiment processing blocks 120 are multiple Arithmetic Logic Units (ALUs). For example, many DSPs are designed to have 2, 4, or 6, or more ALUs. Thus, in one embodiment, processor 100 is a DSP with a multi-ALU architecture that enables the DSP to split various calculations among multiple ALUs to increase throughput and thereby increase efficiency. In another embodiment, processing blocks 120 are parallel processing blocks in a parallel processing system.

Processor 100 is adaptable to utilize parallel processing blocks 120 in ratio optimization. In one embodiment, this may be accomplished by splitting a set of ratios to be searched among the processing blocks 120 and having each processing block 120 find a local maximum or minimum. After all ratios to be searched have been processed by processing blocks 120, the local optimum values are searched to determine a global optimum value. In one embodiment, processing blocks 120 are adaptable to be used to determine the global optimum.

Processor 100 includes memory 130 to store instructions and/or data. In one embodiment, memory 130 includes registers 140 that may be directly accessible by processing blocks 120. Registers 140 may be used to store temporary values to be used in computations performed by processing blocks 120. In one embodiment, memory 130 includes data that will be searched by processing blocks 120 for a ratio maximum or minimum among the data. For example, processor 100 may be part of a system that performs encoding according to the AMR standard, and memory 130 includes the code vector buffer C and the energy vector E. As part of the encoding, processor 100 will use ratio maximization to determine what index k provides the maximum value for:

$${A}_{k} = \frac{{( {C}_{k} )}^{2}}{{E}_{k}} , \qquad ( 5 )$$

where Aₖ is the ratio vector of the square of the code vector and the energy vector at index k.

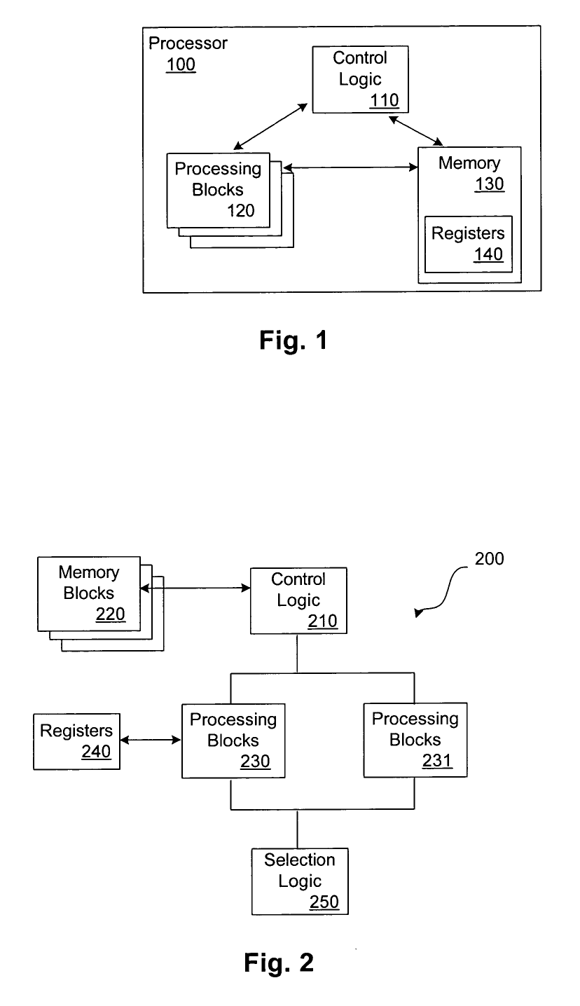

FIG. 2 is one embodiment of a block diagram of a ratio comparing circuit. System 200 is adapted for ratio comparison, and specifically to implement ratio optimization as discussed herein. System 200 includes control logic 210 to direct the flow of control of data and instructions of system 200. The instructions may be received from memory blocks 220, or they may be received from a source outside system 200 (not shown) via communication means coupling system 200 with the source (also not shown). These instructions may be in the form of instructions read from a physical medium, such as a disk, or from an external memory source, such as a flash memory, or from a communications line, such as a network connection. In one embodiment, control logic 210 includes the capability of receiving instructions to enable a system to adapt available resources to implement system 200, or to allocate resources to generate in software or firmware functions of system 200.

System 200 includes memory blocks 220 to store data and/or instructions for access during the operation of system 200. For example, in the embodiment where system 200 is a single processor, memory blocks 220 could be, for example, an on-chip memory bank or an off-chip memory bank. Memory blocks 220 is not limited to being a specific kind of memory, but could include any type known in the art, such as SDRAM, flash, etc. Note that memory blocks 220 may be accessed by processing blocks 230 and 231 through control logic 210. Such a connection may include a direct memory access (DMA) channel for efficient read-write capability to and from memory blocks 220. Memory blocks 220 include the ratio values of the ratios to be searched by system 200. For example, memory blocks 220 may include various buffers of data received by system 200. One or more sets of ratios to be searched could be derived from the elements of the buffers.

Registers 240 are also a bank of memory included in system 200. Register 240 are typically registers accessible by the processing core of a system, where access occurs in the same clock cycle as an instruction, whereas access of memory 220 may take more than a single clock cycle. Thus, registers 240 are specially adapted for use by processing blocks 230 and 231 for storage of temporary variables or temporary results of operations that may be used in by the processing blocks shortly after generating the results. Registers 240 may also include variables or results that will be forwarded to other system memory.

System 200 includes a processing core that includes processing blocks 230 and 231. Processing blocks 230 and 231 operate in parallel, meaning that each processing block performs processing operations (such as arithmetic operations) independent of the other, and substantially simultaneously, meaning within the same instruction cycle. Note that although two processing blocks, 230 and 231, are shown in FIG. 2, system 200 may include other processing blocks in addition to processing blocks 230 and 231 that also operate in parallel to processing blocks 230 and 231. In one embodiment system 200 is part of a larger system that includes other processing blocks in addition to processing blocks 230 and 231, and which are not employed by system 200 for parallel processing of local optimums.

Even though such additional processing blocks may be available and adaptable to use in parallel with processing blocks 230 and 231, there may be efficiency reasons for separating the buffers among only some of the available processing blocks. For example, if the size of the data transfer bus that transfers the ratio component values to system 200 were limited to the width of two ratio components, it could be advantageous to use only two processing blocks. For example, access time and delay issues could cut into the efficiencies gained by parallel processing. Thus, the number of parallel processing blocks could be limited for strategic considerations as well as being limited due to practical considerations such as if there are only two processing blocks available to dedicate to a ratio optimization search.

The parallel architecture of processing blocks 230 and 231 makes system 200 specially adaptable to utilize parallel computational capability to perform ratio optimization. This is accomplished in much the same way known in the art, with added features of parallelism to improve efficiency. The ratio optimization is performed by a system such as system 200 by iteratively accessing for each parallel processing block 230 and 231 a ratio to be tested, and testing it against a local optimum value for the respective processing blocks. If the ratio to be tested is more optimum than the local optimum of the processing block for that iteration, the local optimum is replaced with the value determined to be more optimum. On the next iteration, another ratio to be tested is then compared against the new local optimum. This is repeated until all values have been searched.

Therefore, if a set of ratios, or ratio components, is stored in memory 220, aspects of ratio optimization could be performed in parallel in processing blocks 230 and 231 to increase the efficiency of system 200 in finding the optimum value. For example, a minimum ratio of the set may be found by splitting ratios of the set into subsets between processing blocks 230 and 231, each subset corresponding to a processing block, and each processing block determining a minimum ratio for its own subset of the ratios, independently of the other processing block. Such parallel operation reduces the negative effects of the inherent sequential data dependency by limiting sequential data dependency to a local processing path. Thus, although there is still sequential dependency for each processing block 230 and 231, the number of iterations will be reduced for the step of finding local minimum values for the subset of the respective processing blocks 230 and 231, than if a single processing block searched the entire set.

The process of determining the ratio minimum for this example is completed by selection logic 250. Selection logic 250 receives the local minimum values from processing blocks 230 and 231 and determines which of the two values is the lesser of the two local values, and thus the global optimum from among the set of ratios that was searched. In another embodiment, system 200 includes more processing blocks than processing blocks 230 and 231, and therefore selection logic 250 would determine a global optimum from among all local.

In one embodiment selection logic 250 is a circuit separate from processing blocks 230 and 231, and may or may not be included in the processing core of system 200. Such a circuit would include logic for comparing the resulting local optimum ratios to determine which is globally the best value. In another embodiment, selection logic 250 is a feature of the processing core, which may encompass control logic and processing blocks 230 and 231. The selection logic feature enables system 200 to determine a global optimum value from the local optimum values by using either processing block 230 or processing block 231 to determine which of the two local optimum ratios is the more optimum value, in much the same way the processing block would compare a ratio against the local optimum for the processing block. Another way to accomplish this is to use processing blocks 230 and 231 to perform the searching for the local optimum values, and then utilizing another processing block (not shown) to determine which local optimum value is the global optimum. For example, there may be another processing block coupled to system 200 that is not utilized for searching for local optimums, and in this case, one such processing block could be utilized to find the global optimum.

While the non-memory elements of system 200 may be hardware, they may also be software or firmware that causes processing in parallel pieces of hardware. Furthermore, system 200 may include a combination of hardware, software, or firmware. Every element of system 200, whether hardware or firmware, may reside within a single piece of hardware, such as a processor, or may reside in different hardware that is communicatively coupled to the other elements.

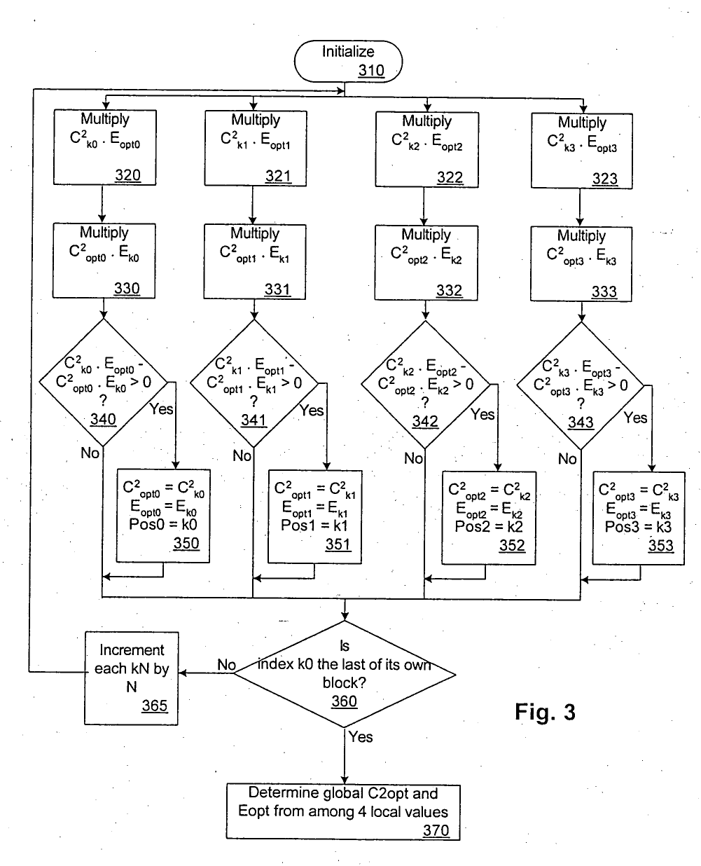

FIG. 3 is one embodiment of a block diagram of a flow diagram of ratio maximization. It is important to note that the functions of ratio optimization depicted in FIG. 3 may be implemented in hardware, or firmware and/or software that causes operations to be performed in parallel processing units, or a combination of these. The efficiency is gained by utilizing an architecture capable of parallel processing. A parallel processing hardware may be specially designed to implement the ratio optimization described herein, or software and/or firmware may be used to adapt a system with a parallel architecture to implement the functions as described.

Ratio maximization consists of finding from among a finite set of values, a ratio that is the largest. While the example embodiment of FIG. 3 focuses principally on ratio maximization, the principles described are equally applicable to ratio minimization. One application where ratio maximization is important is for the algebraic codebook search in AMR speech codecs. The algebraic codebook search consists of determining an index k that maximizes equation (5) above, and reproduced here:

$${A}_{k} = \frac{{( {C}_{k} )}^{2}}{{E}_{k}} , \qquad ( 5 )$$

Traditional algebraic codebook searches fail to utilize the parallelism offered by modern processors that include multiple parallel ALUs or other parallel processing units, and thus do not enjoy the increased efficiency that could result from better utilization of this parallelism.

In the AMR standard, the ratio Aₖ consists of a code vector value Cₖ in the numerator and an energy vector value Eₖ in the denominator. The system is initialized at 310. Initialization may include determining how many parallel processing units to use to perform the search, if the number of processing units is not already preset, and determine which elements of the Cₖ and the Eₖ buffers will be directed to which processing units. In one embodiment the number of parallel processing units used is determined by how many units are available to dedicate to the search function, such as how many ALU's a processor includes. In another embodiment the number of parallel processing units is determined, at least in part, based on the bus width of the incoming elements. For example, if each buffer element is 16 bits, and the bus in a processor performing the search is 64 bits, it may be most convenient to simply transfer four elements on the bus at a time and perform the search of those elements, rather than trying to wait for the bus to transfer elements to other available processing units before beginning the parallel computations. Thus, four parallel processing units would be loaded, even if there are more than four available.

The number of processing units will determine what values must be initialized at step 310. Initialization may include setting initial values for the values to be tested against or the local optimum values. For example, a search for a maximum value according to equation (3):
n₁*dₘₐₓ−nₘₐₓ*d₁>0 (3)
suggests that initial values for nₘₐₓ and dₘₐₓ should be selected, preferably in such a way that the first iteration will prove to be true. Thus, C²ₒₚₜ may be initialized to be −1 and Eₒₚₜ may be initialized to be 1. Thus, the condition of equation (3) will hold true for any values that may be found at the first index k, which causes the optimum ratio to become the ratio at the first value of the index k, and subsequent iterations will be tested against this ratio. Thus, in one embodiment, initialization at 310 includes the conditions:
Cₒₚₜ₀²=Cₒₚₜ₁²=Cₒₚₜ₂²=Cₒₚₜ₃²=−1 (6)
and
Eₒₚₜ₀=Eₒₚₜ₁=Eₒₚₜ₂=Cₒₚₜ₃=−1 (7)
where the subscript opt denotes the value that is the maximum value that has been found up to the current iteration of the search, and the numeric subscripts 0, 1, 2, and 3 denote the processing unit for which the value is the local maximum.

Initialization 310 may also include setting the values of the current buffer indices, denoted in FIG. 3 as k0-k3, to represent the index of the buffer that is currently being searched at each of the parallel processing units, respectively. The global buffer index k, from which k0-k3 are derived, may be split among the parallel processing units by simply having k0=0, k1=1, k2=2, etc. Thus, the values 0, 1, and 2 are the absolute index values of the buffers referenced by k, and k0, k1, etc., are the local index values for the various processing units, and each processing unit has its own index to show which element of the buffer is currently searched in the local processing unit. Furthermore, in accordance with an embodiment where the number of processing blocks N to be used is determined by the bus width of a processor, each local processing block may expect to receive every Nth element of the buffers.

Thus, in one embodiment, the elements of ratios to be tested are split into different blocks based on how many blocks are to be used, as shown by Table 1 below:

TABLE 1
Splitting buffer elements among N blocks

| Blocks | Buffer Elements to Search |
|---|---|
| B₀ | x₀, x_{N}, x_{2N}, x_{3N}, x_{4N}, . . . |
| B₁ | x₁, x_{(N+1)}, x_{(2N+1)}, x_{(3N+1)}, x_{(4N+1)}, . . . |
| . . . | . . . |
| B_{(N-1)} | x_{(N-1)}, x_{(2N-1)}, x_{(3N-1)}, x_{(4N-1)}, x_{(5N-1)}, . . . |

where x0, x1, x2, . . . are buffer elements, and N indicates the number of parallel processing blocks that will be used to perform the ratio maximization search. Table 2 below shows the splitting of buffer elements among four processing blocks, as depicted in the flow diagram of FIG. 3:

TABLE 2
Splitting buffer elements into four blocks

| Blocks | Buffer Elements to Search |
|---|---|
| B0 | x₀, x₄, x₈, x₁₂, x₁₆, . . . |
| B₁ | x₁, x₅, x₉, x₁₃, x₁₇, . . . |
| B₂ | x₂, x₆, x₁₀, x₁₄, x₁₈, . . . |
| B₃ | x₁, x₇, x₁₁, x₁₅, x₁₉, . . . |

In addition to setting initial values for the parallel processing blocks, step 310 may also include setting an initial index value for each processing block, referred to in FIG. 3 as Pos0, Pos1, Pos2, and Pos3, that indicates the index of the buffers where the values that produce the maximum ratio for that processing block are located. In one embodiment, these values are initialized to the first N indices of the buffer searched, where N is the number of processing units. Accordingly, values may be set at initialization 310 so that Pos0=0, Pos1=1, Pos2=2, and Pos3=3.

Once initialization has occurred, the ratios are compared. In one embodiment, this is done by simply comparing the ratios against each other, the ratios being precomputed. Alternatively, the ratios are not precomputed, but computed on the fly, and then compared. While it is contemplated that it may become computationally efficient to perform the comparison of the ratios themselves, it is currently most efficient to replace computations on the ratios themselves with mathematically equivalent substitutes.

In an embodiment such as that shown in FIG. 3, a mathematical alternative to comparing ratios is used. The numerators and denominators of the ratio to be compared and to be compared against are cross multiplied. The square of the element at index k0 of vector C (the numerator of the ratio to be tested) is multiplied by the local maximum of the vector E (the denominator of the optimum ratio being tested against), 320. This is performed in similar fashion in parallel in the other processing branches with the appropriate local indices and local optimum values, 321, 322, and 323. A similar pre-comparison step is to multiply the square of the numerator of the optimum ratio by the denominator of the ratio to be tested, 330. Note that steps 320 and 330 may be performed in any order. The other parallel processing branches perform similar steps at 331, 332, and 333.

The ratios are compared, 340-343. In one embodiment the ratios are compared through a multiply and subtract operation, and the results of the subtraction are compared to zero. For ratio maximization, the product of the square of the numerator of the optimum ratio with the denominator of the ratio to be tested is subtracted from the product of the square of the numerator of the ratio to be tested with the denominator of the optimum ratio similar to equation (3). The result of the subtraction is tested against zero. If the result of the subtraction is greater than zero, the ratio at index k0 is more optimum than the ratio C²ₒₚₜ₀ to Eₒₚₜ₀, 340.

Thus, when the condition of 340 is met, ratio of C²ₖ₀ to Eₖ₀ is set as the optimum ratio for the next iteration, 350. Specifically, C²ₒₚₜ₀ is set to C²ₖ₀, Eₒₚₜ₀ is set to Eₖ₀, and Pos0 is set to k0. This then indicates that for processing path 0, the ratio referenced by index k0 is the local optimum for that processing path. Note that for any given iteration, the condition at any of 340, 341, 342, and 343 may or may not be true. If the condition is true at 340, the condition may or may not be true at, for example, 341. Thus, 350, 351, 352, and 353 are performed when the ratio at the respective k0, k1, k2, or k3 is determined to be the local optimum for that processing path.

It is determined whether index k0 is the last of its own processing path, 360. The indices k0-k3 reference values stored in the buffer or buffers of interest. In one embodiment, the ratios to be searched are derived from multiple buffers, such as a code vector, C, and an energy vector, E. Determining whether index k0 is the last of its own processing path may include determining whether every entry of the buffers has been searched, or alternatively, whether the last of a predetermined number of entries to be searched has been reached. In one embodiment only the index of the first of multiple parallel processing paths need be tested, because if there are no more entries to be tested at the first processing path, there will be no more entries at the other processing paths. This may be, for example, because when the buffer elements are accessed, only the first index reference is used, and an entire block of values, the bus width wide, from the starting index is then accessed for the parallel processing paths. Thus, other indices need not be specified, because only the first index is important in such a block-access approach. Consequently, the first index would also be the only one tested to determine if there are more values to be searched. In another embodiment, where the entries are input to the processing paths via a method other than block access, there may be a need to test other indices to determine if there are other ratios to be tested.

If the index k0 is not the last of its own processing block, each of the local indices, k0, k1, k2, and k3 are incremented by N, 365. This is in accordance with the embodiment where the parallel processing paths receive a block of values from a buffer, and the values are distributed in sequential order among the paths. It is contemplated that alternate methods may be used, and in such embodiments other comparable methods of incrementing the various indices would be used. Thus, in one embodiment, if k0 is currently set to 0, it would be incremented by N, or 4, to 4. Likewise, if k1 is 1, k2 is 2, and k3 is 3, they would each be incremented by N to 5, 6, and 7, respectively. Once the indices are incremented, the next iteration may take place, where the next subset of ratios to be search is received from the set of buffer elements.

If k0 is the last index of its own block, all ratios to be searched have been searched, and a global optimum value is determined from among the local optimum values, 370. Note that in the case where there are four local maximums to be searched for a global maximum, a technique may be used where two parallel processing paths are used to search for the global maximum. Two of the values will already be stored in the first two paths as local optimums. The other two values may then be tested in those parallel paths against the local optimum. This will leave just two values after this iteration, and in similar fashion one of the ratios can then be input to the other processing path and a maximum found between the two. In an alternative embodiment, step 370 may be performed by a separate logic circuit adapted to finding the optimum from among the four values, using the same, similar, or different comparison techniques.

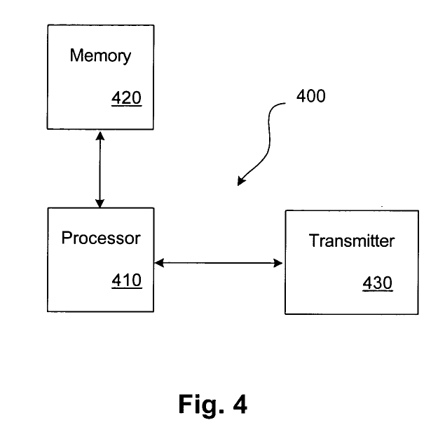

FIG. 4 is one embodiment of a block diagram of elements of a speech compression system. System 400 includes elements adapted to use in speech compression. In one embodiment, system 400 is part of a speech codec that complies with the AMR standard. The key feature of processor 410 is that it includes parallel processing blocks, and is specially adapted, through either hardware design or instructions, to perform ratio optimization by separating the ratios to be searched among the parallel processing blocks. Local optimums are then identified, and a search is made among the local optimums to determine which of the local optimums is a global optimum for the system. In this way the AMR algebraic code vector can be determined in a way more efficient than traditional methods.

Memory 420 is communicatively coupled with processor 410 and may provide instructions to direct the flow of processing of processor 410, as well as provide data to be processed by processor 410. Memory 420 may be, e.g., SDRAM, flash, etc. In one embodiment there is a DMA connection between processor 410 and memory 420. In one embodiment memory 420 includes buffers having elements from which the ratios to be searched by processor 410 are derived. Thus, the parallel ratio optimization of processor 410 operates on ratios or ratio components stored in memory 420.

The results of the search performed by processor 410 may then be stored in memory 420 for further use by system 400, such as transmission to a receiving codec (not shown) via transmitter 430. In one embodiment, transmitter 430 includes a channel coder block to prepare the signal according to a transmission protocol for transmission over a particular communication channel. The channel coder may, for example, add redundancy to the signal to provide a mechanism for error correction/detection that the receiving codec may use to verify the correctness of the incoming signal. In another embodiment, the channel coder block is not part of transmitter 430, but is communicatively coupled with the elements of transmitter 430. Transmitter 430 includes a modulator, or similar device, to receive the output of the channel coder block and convert the signal to a proper form for transmitting over the channel. The channel may be a wireline channel or a wireless channel.

Reference herein to “one embodiment” or “an embodiment” means that a particular feature, structure or characteristic described in connection with the embodiment is included in at least one embodiment of the present invention. Thus, the appearance of phrases such as “in one embodiment,” or “in another embodiment” describe various embodiments of the invention, and are not necessarily all referring to the same embodiment. Besides the embodiments described herein, it will be appreciated that various modifications may be made to embodiments of the invention without departing from their scope. Therefore, the illustrations and examples herein should be construed in an illustrative, and not a restrictive sense. The scope of the invention should be measured solely by reference to the claims that follow.

1. A method for searching, comprising:
splitting among parallel processing blocks elements of a set of values derived form a set of ratios;
computing in parallel processing blocks a set of values derived from a set of ratios, each value of the set computed by a respective processing block;
comparing in the parallel processing blocks the respective computed value against a predetermined value accessible by the respective processing block;
selecting one of the computed value and the predetermined value for a respective processing block that is nearer to an optimum value; and
determining which of the selected values among the processing blocks is nearest to the optimum value.

2. A method according to claim 1, wherein splitting among parallel processing blocks elements of a set of values derived form a set of ratios comprises splitting among the parallel processing blocks a set of pre-computed values derived from the set of ratios, each pre-computed value of the set associated with a respective processing block.

3. A method according to claim 1, wherein splitting among parallel processing blocks elements of a set of values derived form a set of ratios comprises computing in parallel processing blocks the set of values derived from the set of ratios, each value of the set computed by a respective processing block.

4. A method according to claim 3, wherein computing the set of values derived from the set of ratios comprises creating a ratio of an element at an index of a first buffer to an element at a corresponding index of a second buffer.

5. A method according to claim 4, wherein creating the ratio comprises creating a ratio of a square of an element of a correlation vector to an element at a corresponding index of an energy vector in a codebook search.

6. A method according to claim 4, wherein comparing the computed value to the predetermined value comprises comparing the computed ratio to a predetermined ratio.

7. A method according to claim 6, wherein comparing the computed ratio to the predetermined ratio further comprises:
generating a first product of the numerator of the computed ratio multiplied by the denominator of the predetermined ratio;
generating a second product of the numerator of the predetermined ratio multiplied by the denominator of the computed ratio; and
determining whether the first product minus the second product is greater than zero.

8. A method according to claim 7, wherein selecting one of the computed value and the predetermined value that is nearer to the optimum value comprises selecting the computed value if the first product minus the second product is greater than zero, otherwise selecting the predetermined value.

9. A method according to claim 6, wherein comparing the computed ratio to the predetermined ratio further comprises:
generating a first product of the numerator of the computed ratio multiplied by the denominator of the predetermined ratio;
generating a second product of the numerator of the predetermined ratio multiplied by the denominator of the computed ratio; and
determining whether the first product minus the second product is less than zero.

10. A method according to claim 9, wherein selecting one of the computed value and the predetermined value that is nearer to the optimum value comprises selecting the computed value if the first product minus the second product is less than zero, otherwise selecting the predetermined value.

11. A method according to claim 6, wherein comparing the ratio to the predetermined value comprises comparing the ratio to an initial-value ratio for the respective processing block.

12. A method according to claim 6, wherein comparing the ratio to the predetermined value comprises comparing the ratio to a previously computed ratio determined on a previous iteration by the respective processing block to be nearer to the optimum value than a predetermined value of the previous iteration.

13. A method according to claim 1, wherein selecting one of the computed value and the predetermined value that is nearer to the optimum value comprises selecting the greater of the computed value and the predetermined value.

14. A method according to claim 1, wherein the set of values comprises buffer elements obtained from buffers accessible by the respective processing blocks, and
wherein selecting one of the computed value and the predetermined value that is nearer to the optimum value comprises:
storing as the predetermined value in a storage medium accessible by the respective processing block one of the computed value and the predetermined value that is nearer to the optimum value; and
repeating the elements of computing, comparing, and selecting until all available buffer elements have been accessed.

15. A method according to claim 1, wherein determining which of the selected values among the processing blocks is nearest to the optimum value comprises:
if there are two selected values, repeating the elements of comparing and selecting in a processing block, with the first selected value as the predetermined value and the second selected value as the computed value; and
if there are more than two selected values, repeating in parallel processing blocks the elements of comparing and selecting, with the first selected value as the predetermined value and the second selected value as the computed value for each respective processing block.

16. An article of manufacture comprising a machine-accessible medium having content that provides instructions to cause an electronic device to:
computing in parallel processing blocks a set of values derived from a set of ratios, each value of the set computed by a respective processing block;
comparing in the parallel processing blocks the respective computed value against a predetermined value accessible by the respective processing block;
selecting one of the computed value and the predetermined value for a respective processing block that is nearer to an optimum value; and
determining which of the selected values among the processing blocks is nearest to the optimum value.

17. An article of manufacture of claim 16, wherein the content to provide instructions to cause the electronic device to compute the set of values derived from the set of ratios comprises the content to provide instructions to cause the electronic device to create a ratio of an element of a first buffer to an element at a corresponding index of a second buffer.

18. An article of manufacture according to claim 17, wherein the content to provide instructions to cause the electronic device to create the ratio comprises the content to provide instructions to cause the electronic device to create a ratio of a square of an element of a correlation vector to an element at a corresponding index of an energy vector in a codebook search.

19. An article of manufacture according to claim 17, wherein the content to provide instructions to cause the electronic device to compare the computed value to the predetermined value comprises the content to provide instructions to cause the electronic device to compare the computed ratio to a predetermined ratio.

20. An article of manufacture according to claim 19, wherein the content to provide instructions to cause the electronic device to compare the computed ratio to the predetermined ratio further comprises the content to provide instructions to cause the electronic device to:
generate a first product of the numerator of the computed ratio multiplied by the denominator of the predetermined ratio;
generate a second product of the numerator of the predetermined ratio multiplied by the denominator of the computed ratio; and
compare the difference of the first product minus the second product to zero.

21. An article of manufacture according to claim 20, wherein the content to provide instructions to cause the electronic device to select one of the computed value and the predetermined value that is nearer to the optimum value comprises the content to provide instructions to cause the electronic device to:
if a maximum value is searched for, select the computed value if the first product minus the second product is greater than zero, otherwise selecting the predetermined value; and
if a minimum value is searched for, select the computed value if the first product minus the second product is less than zero, otherwise selecting the predetermined value.

22. An article of manufacture according to claim 19, wherein the content to provide instructions to cause the electronic device to compare the ratio to the predetermined value comprises the content to provide instructions to cause the electronic device to compare the ratio to an initial-value ratio for the respective processing block.

23. An article of manufacture according to claim 19, wherein the content to provide instructions to cause the electronic device to compare the ratio to the predetermined value comprises the content to provide instructions to cause the electronic device to compare the ratio to a previously computed ratio determined on a previous iteration by the respective processing block to be nearer to the optimum value than a predetermined value of the previous iteration.

24. A method of searching a set of ratios, comprising:
separating elements of vectors A and B into a number of different sets;
computing in parallel processing units a first product of an indexed element of vector A multiplied by a first member of an initial value pair;
computing in the parallel processing units a second product of an indexed element of vector B multiplied by a second member of the initial value pair;
setting, for each processing unit, the first member of the initial value pair to the value of the indexed element of vector B, and the second member of the initial value pair to the value of the indexed element of vector A, if the first product is greater than the second product for the processing unit;
indexing sequential elements of vectors A and B of the different sets;
repeating the above limitations until a predetermined number of elements of vectors A and B has been searched; and
determining which pair of resulting initial values among the parallel processing units provides a ratio of member one to member two that is nearest to an optimum value.

25. A method according to claim 24, wherein separating the elements into the number of different sets comprises separating the elements into a number of different sets, the number corresponding to a number of available processing units.

26. A method according to claim 24, wherein separating the elements into the number of different sets comprises separating the elements into a number of different sets, the number determined, at least in part, by a number of separate buffer elements fit simultaneously on a data transfer bus from a memory to the processing units.

27. A method according to claim 24, wherein, for ratio maximization:
computing the first product comprises computing the multiplication of an element of the vector A of numerator elements by a denominator member of the initial value pair; and
computing the second product comprises computing the multiplication of an element of the vector B of denominator elements by a numerator member of the initial value pair.

28. A method according to claim 27, wherein vector A comprises a correlation vector and vector B comprises an energy vector.

29. A method according to claim 24, wherein, for ratio minimization:
computing the first product comprises computing the multiplication of an element of the vector A of denominator elements by a numerator member of the initial value pair; and
computing the second product comprises computing the multiplication of an element of the vector B of numerator elements by a denominator member of the initial value pair.

30. A method according to claim 24, wherein determining which pair of resulting initial values among the parallel processing units provides the ratio that is nearest to the optimum value comprises:
if there are two resulting initial value pairs, repeating the elements of computing and setting in a processing unit, with the values of one initial value pair as the indexed elements and the values of the other initial value pair as the initial value pair; and
if there are more than two resulting initial value pairs, repeating the elements of computing and setting in parallel processing units, with the values of one initial value pair as the indexed elements and the values of another initial value pair as the initial value pair for each respective processing block.

31. A apparatus comprising:
control logic to separate elements of a vector A and a vector B into a number of different sets and set a pointer to index various elements of vectors A and B, the control logic to increment the indices in response to receiving an indication from a set of parallel processing units that the parallel processing units have completed a processing function; and
a set of parallel processing units to repeatedly receive from the control logic and process elements of vectors A and B until a predetermined number of elements of vectors A and B has been searched, by:
computing a first product of an indexed element of vector A multiplied by a first member of an initial value pair;
computing a second product of an indexed element of vector B multiplied by a second member of the initial value pair;
setting, for each processing unit, the first member of the initial value pair to the value of the indexed element of vector B, and the second member of the initial value pair to the value of the indexed element of vector A, if the first product is greater than the second product for the processing unit; and
indicating to the control logic that the iteration is complete;
selection logic to determine which pair of resulting initial values among the parallel processing units provides a ratio of member one to member two that is nearest to an optimum value.

32. An apparatus according to claim 31, further comprising a memory to store vectors A and B, communicatively coupled with parallel processing units via a direct memory access (DMA) channel.

33. An apparatus according to claim 31, wherein the control logic separates the elements into the number of different sets based on the number of parallel processing units comprises the set of parallel processing units.

34. An apparatus according to claim 31, wherein the control logic separates the elements into the number of different sets based, at least in part on, a number of separate elements of the vectors fit simultaneously on a data transfer bus from a memory to the processing units.

35. An apparatus according to claim 34, wherein the data transfer bus comprises a 64-bit bus, and the elements of vectors A and B comprise 16-bit values.

36. An apparatus according to claim 31, wherein the parallel processing units search for maximization ratios, and wherein the parallel processing units each compute the first product by multiplying an element of the vector A of numerator elements by a denominator member of the initial value pair, and compute the second product by multiplying an element of the vector B of denominator elements by a numerator member of the initial value pair.

37. An apparatus according to claim 31, wherein the parallel processing units search for minimum ratios, and wherein the parallel processing units each compute the first product by multiplying an element of the vector A of denominator elements by a numerator member of the initial value pair, compute the second product by multiplying an element of the vector B of numerator elements by a denominator member of the initial value pair.

38. A method of searching a codebook, comprising:
separating elements xₖ and yₖ of vectors X and Y among a number N parallel processing circuits to direct elements (x₀ and y₀), (x_{N} and y_{N}), and (x_{2N} and y_{2N}) to processing circuit 0, elements (x₁ and y₁), (x_{N+1} and y_{N+1}), and (x_{2N+1} and y_{2N+1}) to processing circuit 1, and elements (x_{N-1} and y_{N-1}), (x_{2N-1} and y_{2N-1}), and (x_{3N-1} and y_{3N-1}) to processing circuit N−1, where k represents the index of the elements of vectors X and Y;
computing in the parallel processing circuits a product x²_{n,N}·y_{init,N}, where x²_{n,N} represents the square of the value of the element of vector X at index n of processing circuit N, y_{init,N} represents an initial value for vector Y of processing circuit N, and n represents the index of the specific separated elements to be received by processing circuit N;
computing in the parallel processing circuits a product x²_{init,N}·y_{n,N}, where x²_{init,N} represents the square of an initial value for vector X of processing circuit N, y_{n,N} represents the value of the element of vector Y at index n of processing circuit N, and n represents the index of the specific separated elements to be received by processing circuit N;
setting the values of the pair (x_{init,N},y_{init,N}) to the values of (x_{n,N},y_{n,N}) for each processing circuit N for which the condition (x²_{n,N}·y_{init,N}?x²_{init,N}·y_{n,N}) is satisfied, where the operator ? denotes the greater than (>) operation for ratio maximization, and denotes the less than (<) operation for ratio minimization;
incrementing each index n for each processing circuit N;
repeating the above limitations until a predetermined index k of vectors X and Y has been reached; and
determining which of the various pairs (x_{init,N},y_{init,N}) is nearest to an optimum value.

39. A method according to claim 38, wherein separating the elements of vectors X and Y among N parallel processing circuits comprises separating the elements of vector X and Y among a number of parallel processing units which corresponds to the number of elements of the vectors that can simultaneously be transmitted on a data transfer bus coupled with the processing circuits.

40. A method according to claim 38, wherein determining which of the various pairs (x_{init,N},y_{init,N}) is nearest to the optimum value further comprises:
if there are more than two resulting pairs of (x_{init,N},y_{init,N}) to search, repeating the elements of computing and setting in parallel processing circuits with one pair (x_{init,N},y_{init,N}) as (x_{init,N},y_{init,N}), and another pair (x_{init,N},y_{init,N}) as (x_{n,N},y_{n,N}) for each processing circuit until there are two pairs of values remaining; and
if there are two remaining pairs of values, repeating the elements of comparing and selecting in a processing circuit, with the first pair as (x_{init,N},y_{init,N}) and the second pair as (x_{n,N},y_{n,N}).

41. A system comprising:
a processor having:
control logic to separate elements xₖ and yₖ of vectors X and Y into N sets, where set 0 includes elements (x₀ and y₀), (x_{N} and y_{N}), and (x_{2N} and y_{2N}), set 1 includes elements (x₁ and y₁), (x_{N+1} and y_{N+1}), and (x_{2N+1} and y_{2N+1}), and set N−1 includes elements (x_{N-1} and y_{N-1}), (x_{2N-1} and y_{2N-1}), and (x_{3N-1} and y_{3N-1}), each set to be processed by a corresponding separate parallel processing circuit, where k represents the index of the elements of vectors X and Y;
a processing core with parallel processing circuits to repeatedly compute products (x²_{n,N}·y_{init,N}) and (x²_{init,N}·y_{n,N}), where x²_{n,N} represents the square of the value of the element of vector X at index n of processing circuit N and x²_{init,N} represents the square of an initial value for vector X of processing circuit N, y_{init,N} represents an initial value for vector Y of processing circuit N and y_{n,N} represents the value of the element of vector Y at index n of processing circuit N, and set the values of the pair (x_{init,N},y_{init,N}) to the values of (x_{n,N},y_{n,N}) for each processing circuit N for which the condition (x²_{n,N}·y_{init,N}?x²_{init,N}·y_{n,N}) is satisfied, until a predetermined value of k has been reached; and
a value selection circuit to determine which of the various pairs (x_{init,N},y_{init,N}) is nearest to an optimum value; and
a modulator communicatively coupled with the processor to modulate signals for transmission over a communication channel.

42. A system according to claim 41, wherein the modulator is included in a front-end transmission circuit that prepares for transmission over a power line a signal including compressed speech and the pair (x_{init,N},y_{init,N}) that is determined by the processor to be nearest to the optimum value.

43. A system according to claim 42, further comprising a channel coder coupled with the modulator to prepare the signal according to a protocol associated with a communication channel on the power line.

44. A system according to claim 41, wherein the processor is adapted to perform an algebraic codec search according to the Adaptive Multi-Rate (AMR) standard.
